(19) United States
(12) Patent Application Publication
(10) Pub. No.: US 2014/0285576 A1
(43) Pub. Date: Sep. 25, 2014

(54) PRINTHEAD STRUCTURE

(71) Applicant: HEWLETT-PACKARD DEVELOPMENT COMPANY, L.P., Houston, TX (US)

(72) Inventors: Rio Rivas, Corvallis, OR (US); Kellie Susanne Jensen, Corvallis, OR (US); T. Stafford Johnson, Corvallis, OR (US)

(73) Assignee: HEWLETT-PACKARD DEVELOPMENT COMPANY, LP., Houston, TX (US)

(21) Appl. No.: 13/849,109

(22) Filed: Mar. 22, 2013

(51) Int. Cl. B41J 2/14; B41J 2/155

(52) U.S. Cl. CPC B41J 2/14; B41J 2/155
USPC 347/41

(57) ABSTRACT

In one example, a printhead structure includes a cover covering an underlying structure. The cover and the underlying structure define multiple chambers from which fluid may be dispensed through nozzles in the cover and the cover has a stepped edge profile along at least part of the perimeter of the cover.

### BACKGROUND

In some inkjet printers, a media wide arrangement of stationary printheads is used to print on paper or other print media moving past the array. In one type of print bar for media wide inkjet printers, individual printheads are mounted across the width of the media path.

### DRAWINGS

FIGS. 1 and 2 are plan and section views, respectively, illustrating a printhead implementing one example of a new printhead structure.

FIG. 3 illustrates a print bar with multiple printheads each like the printhead shown in FIGS. 1 and 2.

FIG. 4 is a close-up view of one of the printheads in the print bar shown in FIG. 3.

The same part numbers designate the same or similar parts throughout the figures. The figures are not necessarily to scale. The relative size of some parts is exaggerated for clarity.

### DESCRIPTION

A print bar assembly has been developed for media wide inkjet printers in which individual printheads are mounted lengthwise end-to-end in a staggered configuration across the width of the media path. A flex circuit with signal traces is connected to bond pads on each printhead along the upstream side of the printhead, where the print media first arrives for printing. A protective covering is applied to the electrical connections to protect them from the corrosive effects of ink and other environmental degradation. In the past, for other printer designs, signal traces were usually connected to bond pads located at the end of the printhead. In the conventional “end-connect” configuration, the protective covering on the electrical connections on the narrow, end of the printhead also covers the corners of the printhead, protecting them against damage from paper striking the printhead. One unforeseen effect of a “side-connect” configuration in the new print bar, in which the printheads are oriented long-side across the media path, is leaving the corners of the printhead exposed—the protective covering applied to the electrical connections does not extend to the corners of the printhead as it does with the end-connect configuration. Consequently, the corners of the printhead are susceptible to damage from print media striking the printhead during printing.

A new printhead structure has been developed to reduce the risk of damage to printheads with exposed corners. In one example of the new printhead structure, a generally rectangular nozzle plate has rounded corners and a stepped perimeter edge profile. The stepped edge profile maintains the desired overall thickness of the nozzle plate but reduces the thickness (height) of the side wall that can obstruct the print media, allowing the media to pass more easily over the printhead and minimizing any impact forces on the edge of the nozzle plate. In addition, rounding the corners of the nozzle plate eliminates the abrupt edge at each corner where testing shows the greatest impact damage was occurring in the conventional design.

Implementations of the new printhead structure are not limited to a nozzle plate or to printheads with a flex circuit side-connect. For example, the new structure may be implemented in other printhead components exposed to media impact during printing or that might otherwise benefit from the new edge configuration. Accordingly, the examples shown in the figures and described in this Description illustrate but do not limit the invention, which is defined in the Claims following the Description.

As used in this document, a “printhead” means that part of an inkjet printer or other inkjet type dispenser that dispenses fluid from one or more openings. A “printhead” is not limited to printing with ink and other printing fluids but also includes inkjet type dispensing of other fluids and/or for uses other than printing.

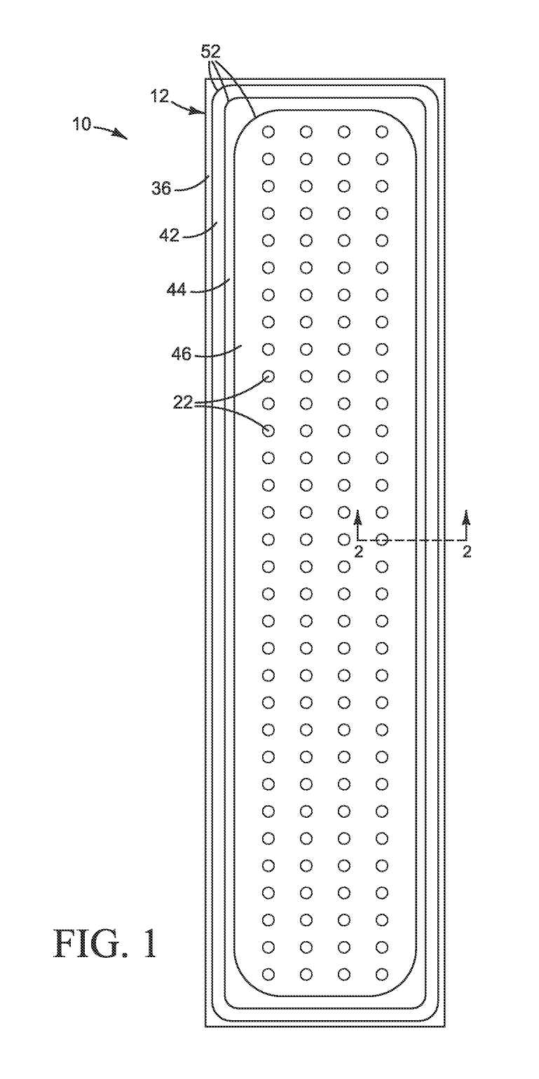

FIGS. 1 and 2 illustrate a printhead 10 implementing one example of a new structure 12 that reduces the risk of damage to exposed corner and edge portions of printhead 10. FIG. 2 is a section view taken along the line 2-2 in the plan view of FIG. 1. Referring to FIGS. 1 and 2, printhead 10 is formed in part in a layered architecture that includes a silicon or other suitable substrate 14, a fluid slot 16 formed in substrate 14 and various conductive, dielectric, and passivation layers. FIGS. 1 and 2 present an idealized depiction of a printhead 10 and, as noted above, the figures are not necessarily to scale. The relative size of some parts is exaggerated to more clearly illustrate features of printhead 10 and structure 12. For example, dispensing nozzles 22 are actually much smaller than those shown in FIG. 1, with hundreds or thousands of nozzles on each printhead 10, and a particular layer in FIG. 2 may appear to be thicker than its actual thickness when compared to another layer in FIG. 2. Also, printhead 10 shown in FIGS. 1 and 2 is just one example of a printhead in which examples of a new edge structure 12 could be implemented. Other printheads with other or different features from those shown are possible.

Referring now specifically to FIG. 2, printhead 10 includes a dielectric 18 formed on substrate 14 and printing fluid dispensers 20 formed over dielectric 18. (Only one dispenser 20 is shown in FIG. 2.) For a thermal inkjet printhead 10, each dispenser 20 is configured as a drop generator that includes a nozzle 22, a fluid dispensing chamber 24, and a thermal firing resistor 26 that ejects ink or other printing fluid drops through nozzle 22. Other configurations for a printing fluid dispenser 20 are possible including, for example, piezoelectric drop generators and stream jetting dispensers. In the example shown, dielectric 18 is a patterned thin film that includes two layers formed on substrate 14—a TEOS (tetraethyl orthosilicate) layer 28 and a BPSG (borophosphosilicate glass) layer 30 overlaying TEOS layer 28. Other materials may also be suitable for dielectric 18, such as undoped silicate glass (USG), silicon carbide or silicon nitride.

Resistors 26 are formed in a resistive layer 32 over dielectric 18. A typical resistive layer 32 is, for example, made of tungsten silicide nitride (WSiN), tantalum silicide nitride (TaSiN), tantalum aluminum (TaAl), tantalum nitride (Ta2N), or combinations of these materials. A conductive metal layer 34 formed on (or under) resistive layer 32 can be used to supply current to resistors 26 and/or to couple resistors 26 to a control circuit or other electronic circuits in printhead 10. A typical conductive layer 34 is, for example, made of platinum (Pt), aluminum (Al), tungsten (W), titanium (Ti), molybdenum (Mo), palladium (Pd), tantalum (Ta), nickel (Ni), copper (Cu) with an inserted diffusion barrier, and combinations of these materials. A passivation layer 36 is formed over conductive metal layer 34 as a dielectric and as a barrier against cavitation (in chamber 24), oxidation, corrosion, and other environmental conditions. A typical passivation layer 36 is, for example, made of silicon carbide (SiC), silicide nitride (SiN), TEOS, and combinations these materials.

Referring again to both FIGS. 1 and 2, nozzles 22 are formed in a nozzle plate 38 formed on or affixed to the underlying structure described above. Nozzle plate 38 helps define dispensing chamber 24 and fluid channels 40 that carry ink or other printing fluids from slot 16 to chamber 24. In operation, ink or other printing fluid feeds into chamber 24 through slot 16 and channel 40, as indicated by flow arrows 48 in FIG. 2. Resistor 26 is energized to heat the ink in chamber 24 to create a bubble that forces ink out of nozzle 22, as indicated by flow arrow 50 in FIG. 2.

In the example shown, nozzle plate 38 is formed in three layers—a first, thinner layer 42 formed on passivation layer 36 and two thicker layers 44 and 46 formed over first layer 42. While all three layers 42, 44, 46 help define dispensing chamber 24 in this example, nozzles 22 are formed in the outermost, third layer 46. Each nozzle plate layer 42, 44, 46 is made of an SU8 epoxy polymer or other suitable material. The thinner, first nozzle plate layer 42 is sometimes referred to as the “primer” layer because it is a thin bottom layer that acts as a buffer to help prevent the highly stressed upper layers 44 and 46 from peeling the underlying thin films. Second layer 44 is sometimes referred to as the “chamber” layer because it forms much of the sidewall of dispensing chamber 24. Third layer 46 is sometimes referred to as the “nozzle” layer because nozzles 22 are formed in this layer.

Third layer 46 terminates inboard of second layer 44 along the perimeter of printhead 10 to form a step 43, as best seen in FIG. 2. Second layer 44 terminates inboard of first layer 42 along the perimeter of printhead 10 to form a second step 45. Also, as shown in FIG. 1, each layer 44, 46 is rounded at the four corners 52 of the rectangular printhead 10. In a conventional printhead design, the nozzle plate chamber and nozzle layers terminate in the same plane along the perimeter of the printhead and make square corners. It was discovered that using such printheads in a page wide print bar, in which the printheads are arranged lengthwise end-to-end across the media path, exposes the unprotected edge of the nozzle plate to the advancing print media, thus subjecting the nozzle plate to damage by media striking the exposed edge, particularly at the corners. Analysis of damaged printheads revealed that the impact of print media striking the exposed edge of the nozzle plate delaminated the chamber and nozzle layers, allowing ink to infiltrate and corrode underlying structures.

The edge profile of the nozzle plate has been made more robust, less susceptible to media damage, by (1) adding a step 43 between the edges of nozzle plate chamber (second) layer 44 and nozzle (third) layer 46 and (2) rounding the corners 52 of each layer 44 and 46. Although a three layer nozzle plate 38 is shown in which the stepped edge profile is formed between layers, more or fewer layers may be used to form a stepped edge nozzle plate 38 including, for example, a single layer nozzle plate 38 in which one or more steps are formed along the perimeter of the single layer. With multiple layers, however, the thickness of each layer may be tailored to a specific function. Usually, the primer layer is thinner for buffering and chamber and nozzle layers are thicker for fluid routing. Multiple layers also help isolate the internal stresses in the individual chamber and nozzle layers from other structures.

The stepped edge configuration maintains the desired overall thickness of nozzle plate 38 but reduces the thickness (height) of the side wall that can obstruct the print media, allowing the media to pass more easily over the printhead and minimizing impact forces on the nozzle plate. Rounding the corners of nozzle plate 38 eliminates the abrupt edge at each corner where testing showed the greatest impact damage was occurring. In addition to substantially reducing impact damage, this stepped, rounded configuration has the dual advantages of not adding steps (or cost) to the fabrication process and allowing a flat outer surface that will not impede the cleaning wiper.

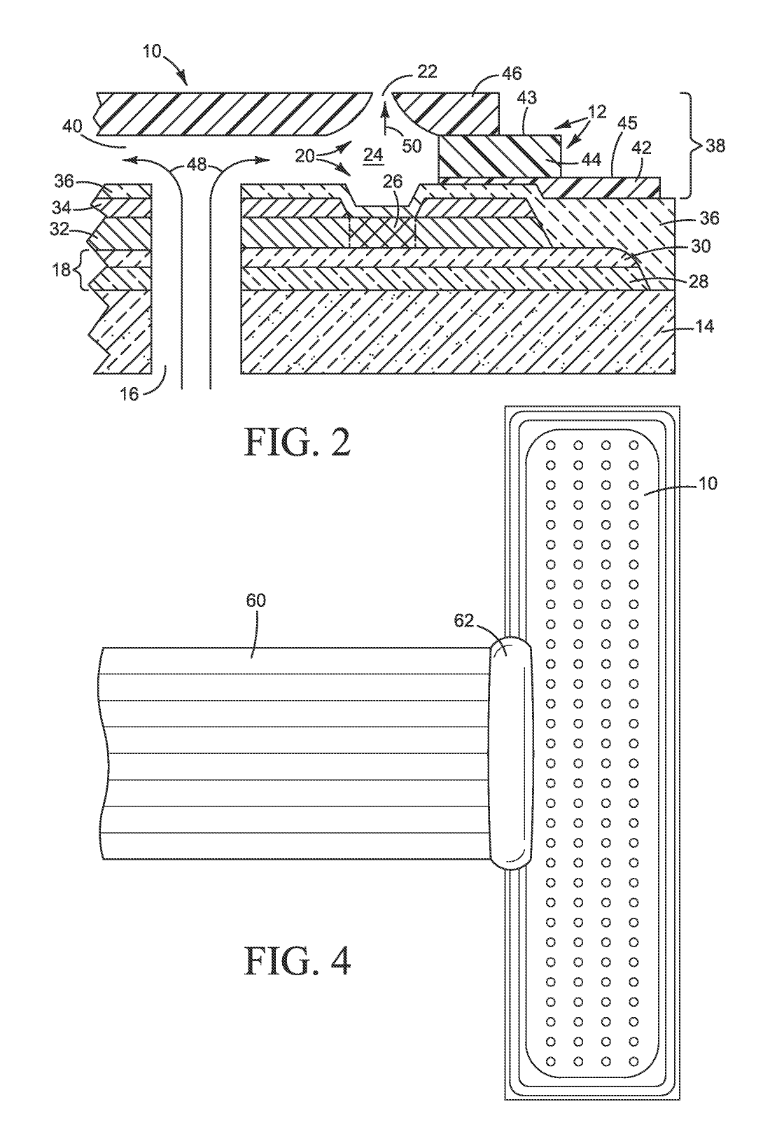

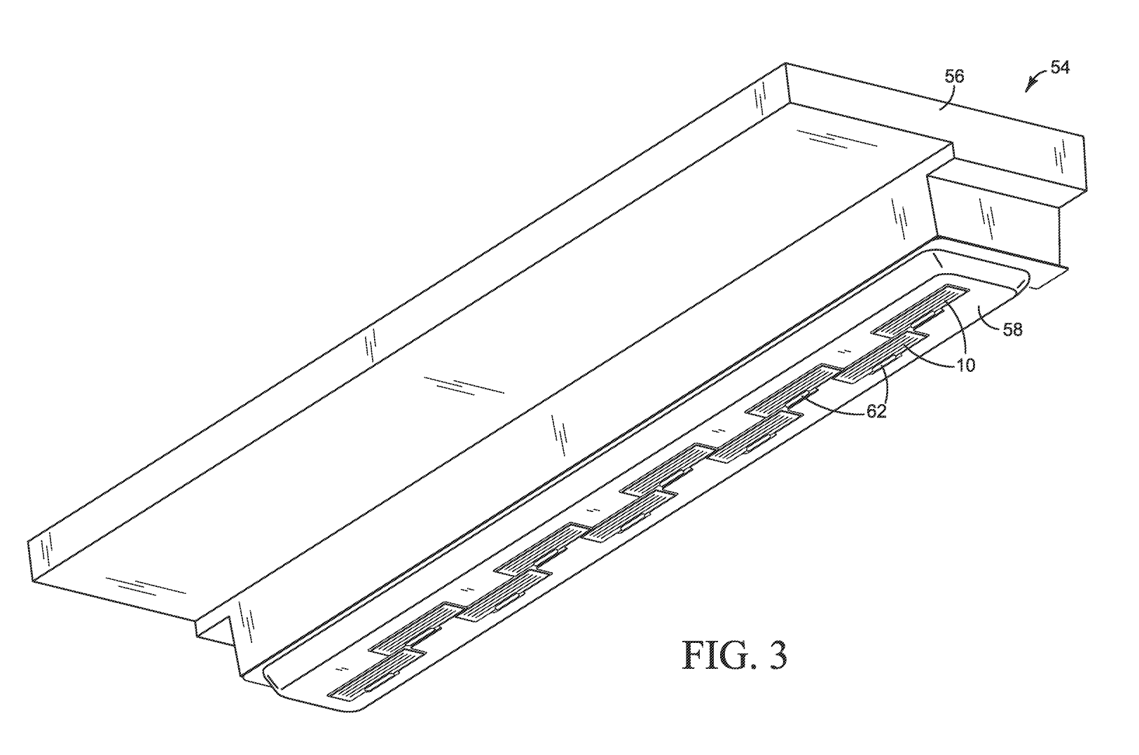

FIG. 3 illustrates a media wide print bar 54 in which multiple printheads 10 are arranged in a row lengthwise across the print bar in a staggered configuration in which each printhead overlaps an adjacent printhead. FIG. 4 is a close-up plan view of one of the printheads 10 in print bar 54. Referring first to FIG. 3, each printhead 10 is mounted to a body 56 and partially surrounded by a shroud 58. In addition to providing a mounting platform for printheads 10, print bar body 56 may also include or house pathways and flow regulators for delivering printing fluids to printheads 10 under the desired conditions. Referring now also to FIG. 4, signal traces and other wires in a flexible circuit 60 are connected bond pads (not shown) on the side of each printhead 10. The connections are protected by an epoxy or other suitable covering 62.

As noted at the beginning of this Description, the examples shown in the figures and described above illustrate but do not limit the invention. Other examples are possible. Therefore, the foregoing description should not be construed to limit the scope of the invention, which is defined in the following claims.

1-4. (canceled)

5. A printhead assembly, comprising:
a printhead having:
multiple fluid ejectors;
a fluid chamber near each ejector; and
multiple nozzles in an elongated nozzle plate covering the fluid chambers, the nozzle plate having a generally rectangular perimeter with rounded corners and an edge profile that includes a step at one or more of the corners; and
a flexible circuit connected to the printhead at a long side of the nozzle plate.

6. The printhead assembly of claim 5, wherein the printhead is a thermal inkjet printhead and the fluid ejectors each comprise a resistor.

7. The printhead assembly of claim 5, wherein the nozzle plate includes two or more layers and the step includes a step between the outermost two layers that extends around the full perimeter of the nozzle plate.

8. The printhead assembly of claim 5, wherein:
the nozzle plate includes exactly three layers defined by a first layer, a second layer on the first layer, and a third layer on the second layer;
the nozzles are formed in the third layer;
the first layer is thinner than the second layer and the third layer; and
the step includes a first step between the edge of the first layer and the edge of the second layer and a second step between the edge of the second layer and the edge of the third layer.

9. A print bar, comprising:
multiple elongated printheads arranged lengthwise end-to-end in a row a staggered configuration in which each printhead overlaps an adjacent printhead, each printhead having a nozzle plate with a stepped edge profile along at least part of the perimeter of the nozzle plate; and
multiple flexible circuits each connected to a corresponding one of the printheads at a long side of the printhead.

10. The print bar of claim 9, wherein the nozzle plate has a generally rectangular perimeter with rounded corners and the stepped edge profile extends around the corners.

11-12. (canceled)

13. The print bar of claim 10, wherein each printhead is mounted to a body and partially surrounded by a shroud.
